(19) United States
(12) Patent Application Publication
(10) Pub. No.: US 2011/0270764 A1
(43) Pub. Date: Nov. 3, 2011

(54) METHOD AND A SYTEM FOR ELECTRONIC TRANSACTION USING POINT OF SALES (POS) DEVICE

(76) Inventor: ALI MIZANI OSKUI, TEHRAN (IR)

(21) Appl. No.: 13/179,529

(22) Filed: Jul. 10, 2011

Related U.S. Application Data
(60) Provisional application No. 61/393,234, filed on Oct. 14, 2010.
(60) Provisional application No. 61/371,710, filed on Aug. 8, 2010.

(51) Int. Cl. G06Q 20/00; H04L 9/32; H04L 9/28

(52) U.S. Cl. 705/75; 705/16; 705/24

(57) ABSTRACT

The various embodiments herein provide a method and system for providing electronic transaction on a Near-Sound Communication Point-of-Sale (NSC_POS) device through a cell phone of a payer. The method comprises of dialling a central server number by a payer through a registered cell phone, arranging the cell phone in the vicinity of the NSC_POS device, broadcasting a sound signal by the central server to the NSC_POS device through the speaker of the cell phone, receiving the sound signal by the microphone of the NSC_POS device, transmitting the received sound signal back to the central server in an encrypted form through the microphone of the cell phone, decoding the received sound signal by the central server. The central server transfers the required amount from the payer's mobile virtual account to a virtual account associated with the NSC_POS device based on information provided in the sound signal.

### CROSS-REFERENCE TO RELATED APPLICATIONS

This application claims the benefit of U.S. provisional patent applications Ser. No. 61/393,234, filed Oct. 14, 2010; 61/371,710 filed on Aug. 8, 2010, which are incorporated herein by reference in their entireties.

### BACKGROUND

1. Technical Field

The embodiments herein generally relates to mobile phone applications. The embodiments herein particularly relate to electronic data transactions and more particularly relates to performing financial transaction through a Point of Sale device using a mobile device of a payer.

2. Description of the Related Art

Presently different kinds of credit cards and electronic identity cards are issued in the world and are widely used for financial transaction purposes. The credit cards and the electronic identity cards are of different kinds such as barcode cards, magnetic cards, contact and contactless cards with chip and the like. However the electronic cards and credit cards come with various defects such as variety of the cards cause confusion among the customers. Also carrying multiple cards becomes tedious and further the customer may forget to carry multiple cards all the time.

The currently existing cards especially the banking magnetic cards often used by the customers involve low security. The payment Point of Sale devices (POS) are divided into two categories like online and offline. In the online POS system, the data is exchanged to the server in the form of tone sounds using the phone lines and the modem. In case of POSs of moving vehicles such as buses and taxies, there is no possibility to access the phone line in which, the installation of wireless online POSs or GSM modules are expensive.

Generally smart cards and offline POSs are used in moving vehicles and the financial data is saved in the smart cards. The major drawback of these smart cards and offline POS is that the payers need to have these memory holding cards always with them. Further the existing POS devices require additional hardware/software components for offline data processing which in turn increases the cost and complexity.

In the light of the foregoing discussions, there exists a need to provide a system and a method for providing an electronic data transaction which does not require any memory holding cards and high capacity memory in offline POS devices. There also exists a need to provide a system and method which does not require any wireless communication equipments in online POS devices for data processing. Furthermore there exists a need to provide a system and method which performs data transfer through the cell phone of the payer to reduce the communication cost and time.

The abovementioned shortcomings, disadvantages and problems are addressed herein and which will be understood by reading and studying the following specification.

### OBJECTS OF THE EMBODIMENTS

The primary object of the embodiments herein is to provide a method and a system for an electronic transaction between a payer and a Point-of-Sale device using a Near Sound Communication (NSC) technique.

Another object of the embodiments herein is to provide a method and a system for an electronic transaction between a cell phone of a payer and a point-of-sale device with the transaction information stored in the PSP/Ummoney center.

Yet another object of the embodiments herein is to provide a method and a system for an electronic transaction between a cell phone of a payer and a point-of-sale device without a need for a dedicated hardware/card reader/software component in the cell phone.

Yet another object of the embodiments herein is to convert the cell phone into one of an electronic identification card/credit card for online mobile transactions across globe.

Yet another object of the embodiments herein is to provide a transaction between a cell phone of the payer and a point-of-sale device independent of the mobile network operators and banking service providers associated with payer.

These and other objects and advantages of the embodiment herein will become readily apparent from the following summary and the detailed description taken in conjunction with the accompanying drawings.

### SUMMARY

The various embodiments herein provide a method for providing an electronic transaction in a Near-Sound Communication Point-of-Sale (NSC_POS) device through a cell phone of a payer using near field communication. The method comprising the steps of dialling a central server number by a payer through a registered cell phone of the payer and arranging the cell phone in the vicinity of the NSC_POS device. The cell phone is arranged such that a speaker of the cell phone is placed in front of a microphone of the NSC_POS device and the speaker of the NSC_POS device is in front the microphone of the cell phone. The method further comprises the steps of broadcasting a sound signal by a central server through the speaker of the cell phone to the NSC_POS device, receiving the sound signal by the microphone of the NSC_POS device, transmitting the received sound signal back to the central server in an encrypted form through the microphone of the cell phone and decoding the received sound signal by the central server. The central server then transfers the required amount from the payer's mobile virtual account to a virtual account associated with the NSC_POS device based on information retrieved from the decoded sound signal. The method further comprises reporting one of a successful transaction and an unsuccessful transaction to the NSC_POS device and terminating connection of the NSC_POS device with the central server.

According to an embodiment herein, the central server reports one of the successful transaction and unsuccessful transaction through a loudspeaker in the cell phone of a payer to the microphone of NSC_POS device in an encrypted manner using tones.

According to an embodiment herein, the central server is one of a PSP server and an Ummoney central server.

According to an embodiment herein, the cell phone of the payer is adapted to function as a modem for connecting the NSC_POS device with the central server for executing an electronic transaction.

According to an embodiment herein, the method for providing electronic transaction in a Near-Sound Communication Point-of-Sale (NSC_POS) device using near field communication further comprises a step of indicating a status of the electronic transaction by the POS after decoding the received data. The status of the electronic transaction is indicated as a display message or a sound message or a hard copy print-out.

According to an embodiment herein, the method of broadcasting the sound signal from the central server comprises the steps of authenticating a MSISDN number of the cell phone and activating an IVR system on the central server. The sound signal transmitted from the central server comprises the MSISDN number of the cell phone and a private key associated with the central server in an encrypted form. The sound signal data received from the NSC_POS device further includes a unique ID number and a unique Private Key allotted to the NSC_POS device. The encryption of the sound signals is performed through a Pair Key Encryption technology.

According to an embodiment herein, the electronic transaction is performed for at least one of a data transfer and financial transaction.

The embodiments herein further provide a Near-Sound Communication Point of-Sale (NSC_POS) device for electronic transfer of a large amount of money from mobile money account of the payer through an IVR system using near field communication. The method comprises calling a PSP IVR server from a NSC_POS device through a cell phone associated with the user of the NSC_POS device, providing destination account number, amount and password as IVR orders through the cell phone, asking for a digital signature of the NSC_POS device user from the IVR server, inserting the digital signature on the NSC_POS device key pad and placing the cell phone near the NSC_POS device. The cell phone is arranged such that the speaker of the cell phone is placed in front of a microphone of the NSC_POS device and the speaker of the NSC_POS device is in front of the microphone of the cell phone, sending a sound signal including a random number to the NSC_POS device by the PSP IVR server, receiving the sound signal by the NSC_POS device, signing the received sound signal data with the digital signature and transmitting back the sound signal data to the IVR server, authenticating the digital signature by the IVR server and performing the electronic fund transfer transaction.

According to an embodiment herein, the digital signature comprises of a private key of the NSC_POS device and a public key of the PSP IVR server.

The embodiments herein further provide a Near Sound Communication One Time Password (NSC_OTP) device for electronic transaction from mobile money account by a merchant through an IVR system. The electronic transaction through an NSC_OTP device comprises the steps of calling to the PSP IVR server by an NSC_OTP device user, inserting the destination account number, amount and password on the NSC_OTP device user's cell phone by IVR orders, the PSP IVR server asking for One-Time-Password (OTP) in case of large fund transfer, inserting a password on the NSC_OTP device keypad by the NSC_OTP device user, placing the cell phone in the vicinity of the NSC_OTP, wherein the cell phone is arranged in a way that the speaker of the NSC_OTP device is in front of the cell phone microphone, sending the One-Time-Password to the PSP IVR server as a sound signal, verifying the One-Time-Password and performing the transaction by the PSP IVR server.

According to an embodiment herein, the sound signal data is transmitted as one of a modem voice and Dual Tone Multi Frequency signal.

According to an embodiment herein, the NSC_POS device comprises a speaker for emitting tone sound signals and transferring data through a sound signal, a microphone for receiving the tone sound signal and receiving data through sound signal, a central processing unit for data processing and connection with elements and peripherals, a memory for storing device information and server details, a communication port for sending mobile ID to other identification devices including access controller, time and attendance system, CPU and memory programming, a sound booster and interpreter for interpreting analog sound signal, a sound generator and booster for generating and boosting sound signal, a keypad for setting and entering password of digital signature and a screen for showing messages, a light array for reporting messages with light signals, a gate open relay and a slip printer for printing result of the electronic transaction.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 is a functional block diagram of a NSC_POS device for an electronic transaction through a payer cell phone, according to an embodiment herein

FIG. 2 is a functional block diagram of a NSC_OTP device for an electronic transaction through a through a cell phone, according to an embodiment herein.

FIG. 3 is the flowchart illustrating a method of performing an electronic transaction on a NSC_POS device using a cell phone of the payer, according to an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments disclosed herein provide a method for providing an electronic transaction on a Near-Sound Communication Point-of-Sale (NSC_POS) device through a cell phone of the payer. The payer dials a central server number through a registered cell phone. The cell phone is arranged in the vicinity of the NSC_POS device. The cell phone is arranged such that the speaker of the cell phone is placed in front of a microphone of the NSC_POS device and the speaker of the NSC_POS device is in front of the microphone of the cell phone. The central server orders to start the payment process by generating a tone sound data. The central server broadcasts the tone sound data as a sound signal to the NSC_POS device through the speaker of the cell phone. The NSC_POS device receives the sound signal through its microphone and transmits the received sound signal back to the central server in an encrypted form through the microphone of the cell phone. The central server obtains the transaction instruction by decoding the received sound signal and transfers the required amount from the payer's mobile virtual account to a virtual account associated with the NSC_POS device based on the information. Further the central server reports one of a successful transaction and an unsuccessful transaction to the NSC_POS device and terminates the connection with the NSC_POS device. The central server reports one of a successful transaction and an unsuccessful transaction to the NSC_POS device by means of tone sound waves in an encrypted manner. The NSC_POS device decodes the received sound data and indicates the status of the electronic transaction as a display message or a sound message or a hard copy print out.

The NSC_POS device according to one embodiment herein is designed for creating the possibility of paying the bus and subway tickets and fare of taxi as well as shopping costs by a cell phone. The NSC_POS device is completely offline and is able to save limited data in its memory and is prepared from simple and inexpensive parts. The NSC_POS device herein enables the cell phone of the payer to function as a modem for connecting the NSC_POS device with the central server for an electronic transaction. The central server verifies the identity of the payer through the caller ID and the corresponding amount is transferred from the payer's mobile virtual account to the bank account of the NSC_POS through the tone sound data exchanged between the NSC_POS and central server through the cell phone of the payer.

The central server herein is an Ummoney/PSP server and the payer communicates with the central server in the form of Interactive voice response.

The central server initiates the transmission of a sound signal to the NSC_POS device by authenticating the MSISDN number of the cell phone and activating an IVR system on the central server. The sound signal transmitted from the central server comprises the MSISDN number of the cell phone and a public key associated with the central server in an encrypted form. Further the sound signal data transmitted from the NSC_POS device includes a unique ID number and a unique Private Key allotted to the NSC_POS device. The encryption of the sound signals is performed through a Pair Key Encryption technology. Here, the electronic transaction is performed for at least one of a data transfer and financial transaction.

For a one or more number of electronic transactions involving large amount of money from mobile money account of the payer by an NSC_POS device through an IVR system, the user of a NSC_POS device calls a PSP IVR server through a cell phone associated with the user of the NSC_POS device, providing destination account number, amount and password as IVR orders through the cell phone. The IVR server asks for digital signature of the user of the NSC_POS device and the user inserts the digital signature on the NSC_POS device using the device key pad and places the cell phone near the NSC_POS device. The cell phone is arranged such that a speaker of the cell phone is placed in front of a microphone of the NSC_POS device and the speaker of the NSC_POS device is in front of the microphone of the cell phone. The PSP IVR server then sends a sound signal including a random number to the NSC_POS device which is received by the NSC_POS device. The NSC_POS device signs the received sound signal data with a private key assigned to it and transmits back to the IVR server by the sound signal data. The IVR server authenticates the digital signature and performs the electronic transaction of the fund. The digital signature comprises of the NSC_POS devices private key and the PSP IVR servers public key.

The embodiments herein further provide an NSC_OTP device for electronic transaction from mobile money account by a merchant through an IVR system. The method of performing the electronic transaction through an NSC_OTP device comprises the steps of dialling to the PSP IVR server by a user of the NSC_OTP device, inserting the destination account number, amount and password on cell phone of the user of the NSC_OTP device by following the instructions/orders/commands of IVR server, asking for One-Time-Password (OTP) by the PSP IVR server in case of large fund transfer, inserting a password on the NSC_OTP device by the user of the NSC_OTP device using a keypad, placing the cell phone in the vicinity of the NSC_OTP, wherein the cell phone is arranged in a way that the speaker of the NSC_OTP device is positioned in front of the cell phone microphone and vice versa, sending the One-Time-Password to the PSP IVR server as a sound signal, verifying the One-Time-Password and performing the transaction by the PSP IVR server. The sound signal data is transmitted as one of a modem voice and Dual Tone Multi Frequency (DTMF) signal.

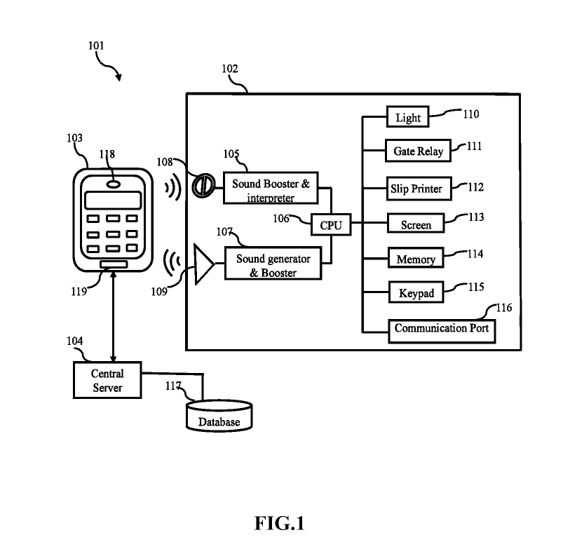

FIG. 1 is a block diagram for a system for electronic transaction on a NSC_POS device through a payer cell phone, according to an embodiment herein. As shown in the FIG. 1, the system includes an NSC_POS device 102 connected to the central server 104 through a payer's cell phone 103. The NSC_POS device 102 comprises a central processing unit 106 for data processing and connection with all elements and peripherals, a microphone 108 for receiving tone sound waves and receiving data through sound signals, loudspeaker 109 for emitting the tone waves and data reception, sound booster and interpreter 105 for interpreting analog sound signal and sound generator and booster 107 for generating and boosting the received sound signal. In case, if there is a powerful CPU, the sound generator and booster 107 is optional. The sound signal may be modem voice or Dual Tone Multi Frequency (DTMF) signal.

The NSC_POS device 102 further comprises a one or more display lights 110 to report the required messages with light signals, a gate relay 111 for opening the gate in case the tickets fair is paid at toll ways, a display screen 113 to display the required messages, a memory 114 for saving the ID number and private key of the NSC_POS device 102 as well as the public key of the central server 104 and other requirements, an optional keypad 115 for setting and entering password of digital signature and a communication port 116 for sending mobile ID to other identification devices such as but are not limited to access controller, time and attendance system, CPU and memory programming and the like. The communication port 116 can be wired or wireless. Optionally, the NSC_POS device 102 is provided with a printer 112 for printing the results of the transaction. The central server 104 herein is one of a PSP server and Ummoney server. The server 104 has the database 117 to store the details of the NSC_POS device 102 and details associated with the cell phone 103 of the payer.

The loud speaker 118 of the cell phone 103 is adapted to transfer orders given by the central server 104 to the NSC_POS device 102 through tone sound data and the microphone 119 of the cell phone 103 transfers the IP and other information provided by the CPU 106 of the NSC_POS device 102 in an encrypted manner to the central server 104.

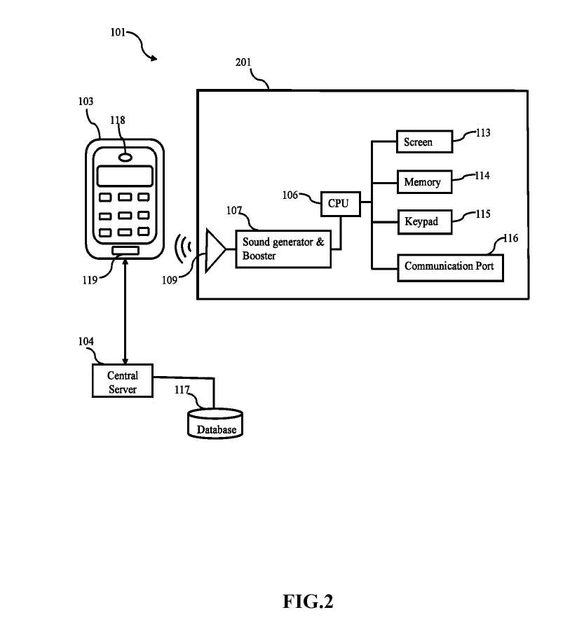

FIG. 2 is an environmental diagram illustrating an electronic transaction through an NSC_OTP device, according to an embodiment herein. According to the FIG. 2, Near Sound Communication One Time Password (NSC_OTP) device 201 is connected to the central server 104 through the payer's cell phone 103. The NSC_OTP device 201 comprises a display screen 113 to show the required messages, memory 114 for saving the ID number and private key of the NSC_OTP device 201 as well as the public key of the central server 104 and other requirements, optional keypad 115 for setting and entering password of digital signature and communication port 116 for sending mobile ID to other identification devices such as but are not limited to access controller, time and attendance system, CPU and memory programming and the like. The communication port 116 can be wired or wireless. The NSC_OTP device 201 further comprises CPU 106 for data processing and connection with all elements and peripherals, loudspeaker 109 for emitting the tone waves and receiving data through sound, and sound generator and booster 107 for generating and boosting sound signal. In case, if there is a powerful CPU, the sound generator and booster device 107 is optional. The sound signal may be modem voice or Dual Tone Multi Frequency (DTMF) signal.

Further according to the FIG. 2 the NSC_OTP device 201 is connected to the central server 104 via the payer's cell phone 103. The server 104 may be one of the PSP server and Ummoney server. The cell phone of the payer 103 comprises a loud speaker 118 to transfer orders given by the server 104 to the NSC_OTP device 201 through tone sound data, a microphone 119 to transfer the encrypted IP and other information provided by the CPU 106 of the NSC_OTP device 201 to the central server 104 through the loudspeaker 109 of the NSC_OTP device 201.

The one time password is a prevalent method of securing transactions in e-banking systems. According to the FIG. 2, for money withdrawing or transferring by IVR applying One Time Password by NSC_OTP device 201, the payer calls the PSP server 104 and inserts destination account number, amount and password on his cell phone according to the respective IVR orders using the keypad 115 of the NSC_OTP device 201. The central server 104 in turn asks the payer for the One Time Password if the transaction is for a large amount of money. The payer then inserts pin code as a second password on NSC_OTP keypad 115 of NSC_OTP 102 and puts the loudspeaker 109 of the NSC_OTP device 102 near the microphone 119 of the cell phone 103. Then the NSC_OTP device 201 creates a One Time Password and sends it to the central server as a sound signal. The central server 104 further verifies the OTP and performs the transaction.

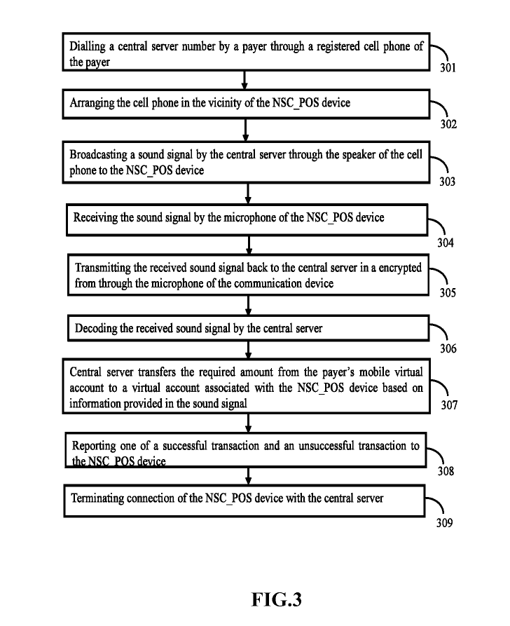

FIG. 3 is the flowchart illustrating the method of performing an electronic transaction on a NSC_POS device using a cell phone of the payer, according to an embodiment of the present disclosure. Before using the NSC_POS system functionalities, the payer need to register with the PSP/Ummoney and charge the virtual account of the cell phone user. The process of online payment starts at a step 301, where the payer dials a special IVR number of the central server. The central server receives the cell phone number of the payer through the caller ID and identifies the payer. The payer then enters the required amount and password using keypad of the cell phone in case of paying taxi fare and money in the shops. There is no need to enter amount and password for paying bus and subway since the amount is fixed for these services.

At the step 302, the payer places the cell phone in vicinity of the NSC_POS device. The cell phone is arranged such that the loud speaker of the cell phone is placed in front of the NSC_POS microphone and the microphone of the cell phone is placed in front of the NSC_POS loud speaker. At the step 303, the central server orders the NSC_POS device to start the payment process through the speaker of the payer's cell phone by broadcasting a sound signal. The sound signal is one of a modem sound and DTMF.

At the step 304, the microphone of the NSC_POS receives the sound signal sent by the central server. The CPU of the NSC_POS device reports the encrypted IP of the NSC_POS device and other information to the microphone of the payer's cell phone using the speaker of the NSC_POS device. Further the cell phone of the payer transfers the encrypted IP to the central server. At the step 305, the NSC_POS transmits the received sound signal back to the central server in a encrypted from through the microphone of the communication device. At the step 306, the central server receives the encrypted IP and decodes the same to perform the transaction. If the virtual account of the cell phone holds the needed amount, central server deducts the amount from the virtual account of the payer cell phone and transfers amount to the bank account or the virtual account for which the NSC_POS device is allocated at the step 307.

At the step 308, the central server reports the success or failure of the financial transaction through a speaker of the cell phone of the user to the microphone of the NSC_POS device using the tone sound data in the encrypted form. The tone sound data can be modem sound and DTMF. Further the NSC_POS device decodes the received data and intimates the user about the success or failure of the transaction. The intimation may be by means of, but not limited to displaying the message, giving sound message, printing the status on the paper, opening the entrance gate by its relay etc. Further, on completion of the transaction, the central server terminates the connection of the NSC_POS device with the central server at the step 309.

Thus the various embodiments of the NOC_POS enable the electronic transaction using the cell phone of the payer through the sound signals.

The NSC_POS of the embodiments herein enables paying tickets by cell phone and saving of all the credits in PSP or Ummoney center. There is no need for providing high capacity memories in offline POSs since all the information is transferred through the payer's cell phone to the central server in online manner. The NSC_POS system provides the connection to the central server using the cell phone of the payer thus eliminating the need for the existence of wireless communication equipments in mobile online POSs or phone line. The NSC_POSs of the present embodiment are made of very simple parts and which are comparatively less expensive. Since the NSC_POS of the present embodiment uses payer's cell phone for the data transfer, the communication cost imposed is less. The NSC_POS of the present embodiment can be used with any kind of cell phone with no aid of extra software and hardware components.

The NSC_POS of the embodiments herein provides high transaction security since it is using pair key encryption algorithms. The NSC_POS of the present embodiment is independent of any MNO (Mobile Network Operator) or any bank.

The embodiments herein provide very high IVR (Interactive Voice Response) security using the digital signer and OTP (One Time Password).

The method of NSC_POS is used in various but not limited to pay the bus ticket, taxi fare, subway ticket, shopping fees and the like. The sound data transfer method mentioned in the embodiments herein is used for transferring amount or data from cell phone to ATM or computer. The POS system disclosed in the embodiments herein is applied for the identification and authentication of applications like but not limited to bank POSs, ATM, time and attendance devices, access control system, traffic control systems, e-tickets, home & garage door opener and different types of burglar alarms, Vending Machine (auto sellers), park meters, gas pumps, funfair and cinema POS. In addition to payment with cell phone, the POS of the embodiments herein also performs the payment with different types of credit cards, by connecting through the SMS, USSD or GPRS or ordinary dialing, if there exists one of the means of wireless communication such as card reader, GPRS, GSM modem module and cell phone module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the embodiments herein with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A method for providing an electronic transaction on a Near-Sound Communication Point-of-Sale (NSC_POS) device, the method comprises:
dialling a central server number by a payer through a registered cell phone of the payer;
arranging the cell phone in the vicinity of the NSC_POS device, wherein the cell phone is arranged such that a speaker of the cell phone is placed in front of a microphone of the NSC_POS device and the speaker of the NSC_POS device is placed in front of the microphone of the cell phone;
broadcasting a sound signal by the central server through the speaker of the cell phone to the NSC_POS device;
receiving the sound signal by the microphone of the NSC_POS device;
transmitting the received sound signal back to the central server in an encrypted form through the microphone of the cell phone;
decoding the received sound signal by the central server;
wherein the central server transfers the required amount from a virtual account of the payers cell phone to a virtual account associated with the NSC_POS device based on an information provided in the received sound signal.

2. The method of claim 1, further comprises:
reporting a transaction to the NSC_POS device and wherein the transaction is selected from a group of transactions comprising of a successful transaction and an unsuccessful transaction; and
terminating a connection of the NSC_POS device with the central server.

3. The method of claim 2, wherein the central server reports a transaction through the loudspeaker in the cell phone of the payer to the microphone of the NSC_POS device by means of tone sound signals in an encrypted manner and wherein the transaction is selected from a group of transactions comprising of a successful transaction and an unsuccessful transaction.

4. The method of claim 1, wherein the central server is a server selected from a group comprising of a PSP server and an Ummoney centre server.

5. The method of claim 1, wherein the cell phone of the payer is adapted to function as a modem for connecting the NSC_POS device with the central server for an electronic transaction.

6. The method of claim 1 further comprises indicating a status of the electronic transaction by the NSC_POS device after decoding the received data.

7. The method of claim 6, wherein the status of the electronic transaction is indicated by displaying a message and wherein the status of the electronic transaction is indicated through a sound message and wherein the status of the electronic transaction is indicated through a hard copy print out.

8. The method of claim 1, wherein broadcasting the sound signal from the central server comprises:
authenticating a MSISDN number of the cell phone; and
activating an IVR system on the central server.

9. The method of claim 1, wherein the sound signal broadcast from the central server comprises the MSISDN number of the cell phone and a private key associated with the central server in an encrypted form.

10. The method of claim 1, wherein the sound signal data transmitted from the NSC_POS device includes a unique ID number and a unique Private Key allotted to the NSC_POS device.

11. The method of claim 1, wherein the sound signals are encrypted using a Pair Key encryption technology.

12. The method of claim 1, wherein the electronic transaction is a data transfer process and wherein the electronic transaction is a financial transaction.

13. The method of claim 1, further comprises a process of providing an electronic transaction of a large amount of money from a mobile money account of the payer by an NSC_POS device user through an IVR system and wherein the process of providing the electronic transaction of the large amount of money from the mobile money account of the payer by an NSC_POS device comprises:
calling a PSP IVR server by a user of the NSC_POS device through a cell phone associated with the user of the NSC_POS device;
providing a destination account number, an amount and a password based on an instruction received from the IVR system through the cell phone;
asking for a digital signature of the user of the NSC_POS device by the PSP IVR server;
inserting the digital signature of the user on the NSC_POS device using a key pad in the NSC_POS device and
placing the cell phone near the NSC_POS device and wherein the cell phone is placed near the NSC_POS device in such a manner that a speaker of the cell phone is placed in front of a microphone of the NSC_POS device and the speaker of the NSC_POS device is placed in front of the microphone of the cell phone;
sending a tone sound signal including a random number to the NSC_POS device by the PSP IVR server;
receiving the tone sound signal by the NSC_POS device;
signing the received tone sound signal data with the digital signature and transmitting back the tone sound signal data to the PSP IVR server;
authenticating the digital signature by the PSP IVR server; and
performing the electronic transaction for transferring the fund.

14. The method of claim 13, wherein the digital signature comprises the private key of the NSC_POS device and the public key of the PSP IVR server.

15. The method of claim 1 further comprises a process of providing an NSC_OTP device for performing an electronic transaction from a mobile money account by a merchant through an IVR system.

16. The method of claim 15, wherein performing the electronic transaction through an NSC_OTP device comprises:
Calling the PSP IVR server by an NSC_OTP device user;
inserting a destination account number, an amount and a password on the cell phone of the user of the NSC_OTP device based on the instruction received from the IVR system;
asking for One-Time-Password (OTP) in case of a large fund transfer by the PSP IVR server;
inserting a password on the NSC_OTP device using a keypad on the NSC_OTP device by the user;
placing the cell phone in the vicinity of the NSC_OTP device, wherein the cell phone is placed in a such a way that the speaker of the NSC_OTP device is arranged in front of the microphone on the cell phone;
sending the One-Time-Password to the PSP IVR server as a sound signal;
verifying the One-Time-Password and performing the transaction by the PSP IVR server.

17. The method of claim 1, wherein the sound signal data is transmitted is a modem voice and wherein the sound signal data is transmitted a Dual Tone Multi Frequency (DTMF) signal.

18. A Near Sound Communication Point-of-Sale (NSC_POS) device comprising:
a speaker for emitting a tone sound signal and wherein the tone sound signal includes a data to be transferred;
a microphone for receiving the tone sound signal and wherein the tone sound signal includes a data;
a central processing unit for processing the data and connecting with a plurality of peripheral devices;
a memory for storing a device information and a server details;
a communication port for sending a mobile ID to an identification device and wherein the identification device includes an access controller, a time and attendance system, CPU and a memory programming device;
a sound booster and interpreter for interpreting analog sound signal; and
a sound generator and booster for generating and boosting sound signal.

19. The NSC_POS device of claim 18 further comprises a keypad for setting and entering a password or a digital signature.

20. The NSC_POS device of claim 18 further comprises:
a screen for displaying messages;
a light array for reporting messages with light signals;
a gate open relay; and
a slip printer for printing a result of an electronic transaction.
